(19) United States
(12) Patent Application Publication
(10) Pub. No.: US 2015/0354897 A1
(43) Pub. Date: Dec. 10, 2015

(54) CRUCIBLE LINER

(71) Applicant: SACHSISOLAR, INC., Boston, MA (US)

(72) Inventor: Christoph SACHS, Herzogenrath (DE)

(73) Assignee: Sach Sisolar ,Inc.

(21) Appl. No.: 14/655,580

(22) PCT Filed: Feb. 3, 2014
(86) PCT No.: PCT/US2014/014393

§ 371 Date: Jun. 25, 2015

Related U.S. Application Data
(60) Provisional application No. 61/760,900, filed on Feb. 5, 2013.
(60) Provisional application No. 61/916,344, filed on Dec. 16, 2013.
(60) Provisional application No. 61/916,575, filed on Dec. 16, 2013.

(51) Int. Cl. F27B 14/10; F27D 1/00; C01B 33/021; F27D 1/16

(52) U.S. Cl. CPC F27B 14/10; F27D 1/16; F27D 1/0003; C01B 33/021; F27B 2014/104

(57) ABSTRACT

A liner is placed into a crucible to prevent semiconductor material from contacting the interior surfaces of the crucible and to allow the crucible to be reused in the making of semiconductor ingots.

### CROSS REFERENCE TO RELATED APPLICATIONS

This claims priority to and the benefit of provisional U.S. patent application Ser. No. 61/916,344 filed Dec. 16, 2013, provisional U.S. patent application Ser. No. 61/916,575 filed Dec. 16, 2013, and provisional U.S. patent application Ser. No. 61/760,900 filed Feb. 5, 2013. The entirety of each of these three applications is incorporated herein by reference.

### TECHNICAL FIELD

The invention generally relates to a liner for a crucible.

### BACKGROUND INFORMATION

Silicon is a semiconductor material used to produce semiconductor devices such as integrated circuits and solar cells. Crystalline silicon wafers are made from high purity electronic grade silicon, and these wafers are used as the substrates for manufacturing solar cells. Whether silicon or another type of semiconductor material is used to produce wafers for creating solar cells, the process of making the wafers involves melting the semiconductor material at high temperatures within a crucible to form an ingot. The wafers then are sliced from the formed ingot. The efficiency of the resulting solar cells is strongly impacted by the presence of structural defects and impurities contained within the ingot and the wafers sliced therefrom.

To create an ingot from which the wafers are sliced, semiconductor material is placed into the crucible and heated to a very high temperature. The heat causes the semiconductor material within the crucible to melt and form a molten mass of the semiconductor material. This molten material is then cooled within the crucible to form an ingot. During the melting and cooling stages, the forming ingot is in direct contact with the interior of the crucible.

Conventional crucibles are made of fused silica which is not wetted by the molten material but dissolves upon contact with the molten material. The interior of the crucible may be coated with a thin layer of silicon nitride to protect the fused silica and to allow for release of the ingot from the crucible. A main disadvantage of the conventional crucible with the silicon nitride coating is that at high temperatures impurities from the fused silica material of the crucible can diffuse into the molten material and the formed ingot. The diffusion of these impurities into the molten and solid material results in the outer edge or boundary of the formed ingot having extremely low electronic quality. This outer edge or boundary portion of the ingot is commonly known as the red zone, and this red zone can comprise up to 25% of the resulting ingot. The quality of the material in the red zone is so low that it cannot be used to produce wafers for solar cells, and thus a significant amount of the valuable silicon feedstock is wasted. Additionally, during the cooling down phase, thermal stress and mismatching of thermal properties can cause the fused silica crucible to break. Therefore, a conventional crucible has the disadvantage of forming impurities in the ingot and by breaking in the cooling down stage such that the crucible cannot be reused. Also, a conventional crucible typically is broken to release the cooled ingot even if the crucible did not crack or break during the required heating and cooling to form the ingot.

In addition to the above-described conventional crucibles, reusable crucibles also are known. With a reusable crucible, an internal coating that is dense and stable is needed and used in order to prevent damage to the crucible and to prevent bonding between the ingot and the crucible's interior walls during solidification of the molten material. It is known to use graphite for the crucible and silicon nitride as the internal coating when making a reusable crucible. However, given the different thermal properties of the silicon nitride coating and the graphite of the crucible, a multi-layer coating system is needed to maximize the coating thickness. And, after a single use of such a reusable crucible, the coating has to be removed and reapplied for the next use of the crucible. Therefore, a reusable crucible has the significant disadvantage of requiring much labor and time to prepare the reusable crucible for each use.

It is known to use graphite foil as a liner for a crucible, and it also is known to use fused silica as a liner for a crucible. Graphite foil reacts with the molten material, and its smooth surface makes it difficult to apply protective coatings to it. Fused silica inputs oxygen as an impurity into the molten material, and the fused silica insert is fragile and not flexible.

### SUMMARY OF THE INVENTION

The invention generally relates to a new liner for a crucible. The liner includes a fibrous material, and it is made to match the interior shape of the crucible. The liner is composed of one or more high purity materials that are non-reactive with the molten semiconductor material and that do not impart contaminates into the material. The liner allows the crucible to be reused. That is, while a new liner typically is required to form each ingot, the same crucible can be reused. The liner comes out of the crucible with the cooled ingot, and then the liner is discarded after it is removed from the freed ingot. The inventive liner allows the creation of high purity semiconductor ingots with very little or no edge contamination. The inventive liner also allows a reusable crucible (such as a graphite crucible) to be used in an existing ingot growth furnace to create such high purity ingots.

A liner according to the invention can have multiple layers with at least one of the layers including the fibrous material. More than one fibrous layer can be used, and the texture of the fibrous material improves the bonding strength of coatings as compared to the smooth surfaces of commonly used silica or graphite crucibles. The liner has a degree of flexibility and ductility such that the liner can withstand a certain amount of bending or flexing without failure. While the liner will be created with a shape that matches the interior shape of a given crucible, the flexibility and ductility of the liner allows the liner to move and adjust somewhat after being placed within the crucible. Also, the liner typically will be less than 10 millimeters (mm) in thickness and will have an impurity content of less than 500 parts per million by weight (ppm w) and preferably less than 100 ppm w.

In one aspect, the invention relates to a liner for a crucible wherein the liner comprises an inner layer, and outer layer, and one or more fibrous layers disposed between the inner and outer layers. The inner layer faces a molten semiconductor material when the liner is placed within the crucible. The outer layer faces one or more inner surfaces of the crucible. In accordance with this aspect of the invention, the inner layer can comprise a ceramic material or a non-metallic heat-resistant material, such as, for example, carbon, silicon carbide, silicon oxide, silicon nitride, silicon oxycarbide, silicon oxynitride, boron carbide, boron nitride, and/or combinations thereof. The inner layer ideally has no or low reactivity with the molten semiconductor material. The outer layer can comprise a material that is not reactive with the crucible, and the outer layer can comprise a fibrous material. Any one or more of the one or more fibrous layers can comprise carbon fibers or silicon oxide fibers, and any one or more of the one or more fibrous layers can comprise a fabric, where the term fabric includes any material formed by weaving, knitting, pressing, felting, or otherwise assembling or combining multiple fibers or filaments. The one or more fibrous layers provide mechanical stability to the liner and also allow the liner to be formed into a shape that matches the inner surfaces of the crucible.

In another aspect, the invention relates to a liner for placing into a crucible to prevent material placed into the liner from contacting the interior surfaces of the crucible and for allowing the crucible to be reused, wherein the liner comprises fibrous and ceramic materials. In accordance with this other aspect of the invention, the liner can comprise a plurality of layers wherein at least one of the plurality of layers comprises the fibrous material and at least one other of the plurality of layers comprises the ceramic material. The fibrous material can be a fabric, and the ceramic material can be silicon nitride.

In yet another aspect, the invention involves a liner for a crucible that comprises a top layer and a bottom layer. The top layer comprises a ceramic material, and a surface of the top layer contacts material placed into the liner when the liner is placed into the crucible. The bottom layer comprises a fibrous material, and a surface of the bottom layer contacts at least some of interior surfaces of the crucible when the liner is placed into the crucible. In accordance with this aspect of the invention, the ceramic top layer can be silicon nitride, and the fibrous material of the bottom layer can include carbon fibers and/or silicon oxide fibers. There can be one or more intermediate layers between the top layer and the bottom layer such as, for example, a first intermediate layer and a second intermediate layer wherein the first intermediate layer comprises a fibrous material and the second intermediate layer comprises silicon nitride.

In still another aspect, the invention involves a liner for placing into a crucible to prevent silicon from contacting the interior surfaces of the crucible and for allowing the crucible to be reused in the making of silicon ingots, wherein the liner comprises an outer layer, an inner layer, and a plurality of intermediate layers between the inner and outer layers. The outer layer contacts at least some of the interior surfaces of the crucible when the liner is placed into the crucible, and the outer layer comprises a first fibrous material. The inner layer contacts silicon placed into the liner when the liner is placed into the crucible, and the inner layer comprises silicon nitride. The plurality of intermediate layers comprises a first intermediate layer and a second intermediate layer, wherein the first intermediate layer comprises a second fibrous material and the second intermediate layer comprises silicon nitride. In accordance with this aspect of the invention, the first fibrous material can comprise carbon fibers and the second fibrous material can comprise silicon oxide fibers. The second intermediate layer can comprise a coating of the silicon nitride on one side of the first intermediate layer, and the inner layer can comprise a coating of the silicon nitride on the other side of the first intermediate layer.

In another aspect, the invention involves a liner for placing into a crucible to prevent silicon from contacting the interior surfaces of the crucible and for allowing the crucible to be reused in the making of silicon ingots, wherein the liner comprises an exterior portion and an interior portion. The exterior portion is configured to contact at least some of the interior surfaces of the crucible when the liner is placed into the crucible, and the exterior portion comprises a first fibrous material. The interior portion comprises a second fibrous material, a first silicon nitride coating on a first side of the second fibrous material, and a second silicon nitride coating on a second side of the second fibrous material, wherein the first silicon nitride coating adjoins the exterior portion and the second silicon nitride coating is configured to contact silicon placed into the liner when the liner is placed into the crucible.

In yet another aspect, the invention involves a method of making silicon ingots, wherein the method comprises placing a liner into a crucible to create a lined crucible, heating the lined crucible when it contains silicon to melt the silicon contained within the lined crucible, and removing the liner from the crucible after the melted silicon has cooled sufficiently to form a solid silicon ingot, and repeating the placing/heating/removing steps using the same crucible with another liner to make another solid silicon ingot. Each of the liners comprises a fibrous material and a ceramic material, and each solid silicon ingot is removed from the crucible along with each of the liners.

In any of these aspects of the invention, the fibrous material can be a refractory (that is, resistant to heat) material such as carbon, silicon carbide, silicon oxide, silicon nitride, silicon oxycarbide, silicon oxynitride, boron carbide, boron nitride, and/or combinations thereof, and the fibers can be arranged in a regular or irregular fashion to form a network, web, woven fabric, or non-woven fabric. The ceramic material can be, for example, silicon nitride, silicon oxide, or silicon carbide, and the ceramic material can be applied to the fibrous layer(s) by brushing, spraying, chemical deposition, or some other application technique. A liner according to the invention is flexible and ductile enough to allow for some movement of the pre-formed liner after its placement into the crucible for which the liner has been pre-formed. The liner can be formed as a flat sheet, but more typically it will be formed to fit and match with the interior of a particular crucible.

These and other aspects, features, advantages, and benefits of the invention will be understood better by reference to the drawings and the following detailed description. It is noted however that the invention is not limited to only the particular disclosed embodiments.

### BRIEF DESCRIPTION OF THE DRAWINGS

FIGS. 1a through 1d depict the process steps for casting an ingot using a reusable crucible and a crucible liner according to the invention.

FIGS. 2a and 2b are schematics of a reusable crucible and a layered structure of a crucible liner according to the invention.

FIGS. 3a and 3b are schematics of a reusable crucible and an edge of the crucible.

FIGS. 4a and 4b are schematics of a crucible and structure of a crucible liner.

### DESCRIPTION

The present invention relates to a liner to be inserted into a crucible for the process of melting a semiconductor material to form an ingot. The liner can be composed of multiple layers such as an inner layer, an outer layer, and possibly also one or more intermediate layers disposed between the inner and outer layers. The inner layer is in contact with the molten material and the outer layer faces the interior surface of a crucible. Any one of the inner, outer, and/or intermediate layers can itself be comprised of a plurality of layers.

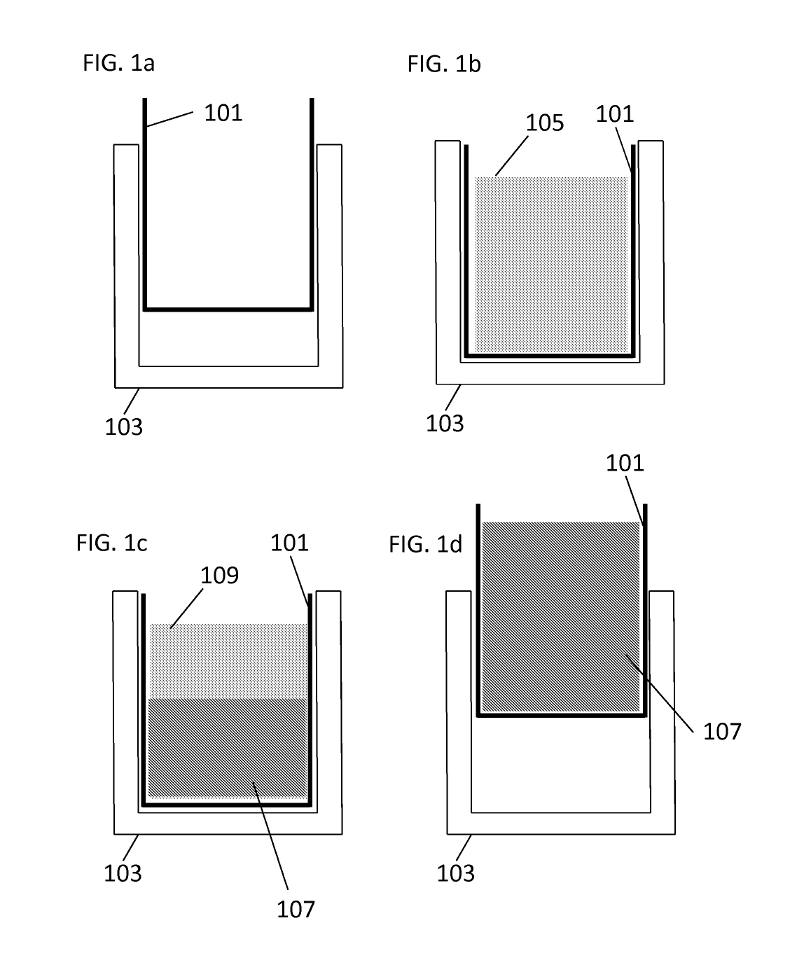

The present invention relates to a liner 101 to be used with a reusable crucible 103, as shown cross-sectionally in FIGS. 1a through 1d. The size and shape of the crucible can vary, and the liner of the invention can be varied in size and shape as well. FIGS. 1a through 1d show cross sections of the liner 101 and the crucible 103 as they are used together in a process of melting and then cooling a semiconductor material. The crucible liner 101 is inserted into the crucible 103 as shown in FIG. 1a. The liner comprises at least one layer, but the liner may comprise a plurality of layers, and the layers may be formed from fibrous material, ceramic material, and other coatings or protective layers. Once the liner 101 is inserted into the crucible 103, solid pieces of a semiconductor material 105 are placed within the liner as shown in FIG. 1b. Next, the crucible 103, the liner 101, and the semiconductor material 105 are inserted into an ingot growth furnace to heat the semiconductor material 105 until it melts and becomes liquid. In FIG. 1c, the semiconductor material 105 is shown partially in a molten state 109 and partially in a solidified state 107. During the cooling stage, the molten material 109 is directionally solidified into the solidified ingot 107. Ingot growth furnaces are commercially available. The DSS450HP growth furnace made by GT Advanced Technologies, Inc. is one example of an existing ingot growth furnace. Once solidification is complete, the liner 101 is removed from the reusable crucible 103, allowing for the crucible 103 to remain intact. The formed ingot 107 then is removed from the liner 101.

In general, any reusable crucible can be used in conjunction with the liner. The dimensions of the reusable crucible and the crucible liner may be adjusted for different crystal growth systems and applications. For example, a crucible liner of the invention may have a width and length of about 870 mm and a height of about 420 mm to hold and process approximately 450 kg of silicon feedstock and molten material. The liner of the present invention can be formed into many different configurations and sizes to accommodate various sizes and shapes of crucibles and/or other containers.

### Molten Material

The present invention may be used in conjunction with many varying types of materials, where non-reactivity and control of contaminates is needed. Metals, alloys, semiconductor materials, and other chemical compositions that require the application of high temperatures can be used in conjunction with the present invention.

The liner of the present invention can be used with a variety of semiconductor materials. Silicon currently is the most commonly used semiconductor material in the making of wafers for use as the substrates of solar cells.

In one disclosed embodiment, high-purity, semiconductor-grade silicon (only a few parts per million of impurities) is melted in a quartz or graphite crucible. It is an important aspect of the invention that contaminates and impurities are controlled and not introduced into the silicon (or other semiconductor material feedstock that is being used) from the liner or from the crucible.

In some embodiments of the invention, the liner is inserted into a crucible and is filled with pure polysilicon chips, but various grades and compositions of silicon feedstock can be used. In addition, a variety of silicon feedstock geometries can be used such as melts, rods, pellets, scrap, etc.

### Ingot Formation

With the liner of the invention, ingots can be formed while the structural integrity of the crucible is retained and impurities are controlled. It should be appreciated that the liner of the present invention can be used in conjunction with various methods and various apparatuses to effectively melt materials at high temperatures.

Directional solidification and progressive solidification methods can be employed with the current invention. For information on directional solidification, see, for example, J. of Mat. Res., vol. 9, iss. 06, 1994; J. of Mat. Res., vol. 308, iss. 1, 2007; U.S. Pat. No. 3,810,504; U.S. Pat. No. 3,897,815; and JOM, Jun. 1992, vol. 44, iss. 6. In directional solidification, solidification occurs from one end of the container and progresses to another end of the container. For example, in a crucible, solidification starts as the bottom of the crucible and progresses towards the top of the crucible. Progressive solidification, also known as parallel solidification, is solidification that starts at the walls of the casting vessel and progresses perpendicularly from that surface. The geometrical shape of the mold cavity has direct effect on progressive and directional solidification.

Directional solidifying can be carried out in a separate crucible after silicon is poured into it from a melting crucible. This process is usually referred to as silicon casting. In directional solidification, the silicon is melted and directionally solidified in the same crucible. The method is simpler than casting because no melt pouring is involved. However, there are longer reaction times at high temperature between the molten material and the crucible, as well as longer turnaround times. By using a high-purity reusable crucible (such as a graphite crucible) with a liner of the invention, directional solidification can be achieved without the problem of impurities being introduced into the molten material.

Directional solidifying of silicon in a quartz (fused silica) crucible leads to significant cracking problems due to sticking and thermal expansion mismatch between the solidified silicon and the crucible. Prior attempts of solving this problem in quartz crucibles involve deliberately weakening the inner wall of the quartz crucible (See, Khattak, C. P., and Schmid, F. (1978) IEEE 13^{th} Photovoltaic Specialists Conf. Record, IEEE, New York, 137). High-density graphite crucibles were introduced for directional solidification as a way of avoiding the cracking (Ciszek, T. F. (1979) J. Crystal Growth 46, 527). Most crucible-based commercial methods of creating silicon ingots that are used in the creation of solar cells use directional solidifying in the melting crucible.

In one disclosed embodiment, a multilayer liner of the invention is inserted into a graphite crucible where a semiconductor material, such as silicon, is placed into the liner/crucible system. The semiconductor material is melted according to known directional solidification methods. Aspects of the present invention allows for the ingot to form while contamination is controlled and the structural integrity of the crucible is preserved.

The Czochralski method is known as a method of crystal growth used to obtain single crystals of semiconductors (e.g., silicon, germanium and gallium arsenide), metals (e.g., palladium, platinum, silver, gold), salts, and synthetic gemstones. See, for example, Materials Transactions, JIM, Vol. 38, No. 11 (1997); J. of Crystal Growth, Vol. 97, Iss. 3-4, Oct. 1989; J. of Alloys and Compounds, Vol. 380, Iss. 1-2, Oct. 2004; PCH/PhysicoChemical Hydrodynamics (ISSN 0191-9059), vol. 5, no. 1, 1984. For example, in the Czochralski process, high-purity silicon is melted down in a crucible and a seed crystal mounted on a rod is dipped into the molten silicon. The rod is pulled upwards and rotated at the same time. A large, single-crystal, and cylindrical ingot is extracted from the melt by precisely controlling the temperature, rate of pulling, and speed of rotation. Production of single crystals in the Czochralski process takes place in single crystal furnaces. The quartz crucible is placed inside the furnace, in an inert argon atmosphere. When the polycrystalline silicon becomes a liquid or molten material (at 1400 degrees Celsius), a thin rod with single crystal silicon comes into contact with its surface to serve as the seed to initiate crystallization. The process of crystal growth can be controlled by adjusting the speed of pulling the seed out of the crucible, the rotation speed of the rod, or the temperature, pressure and composition of the atmosphere inside the furnace.

The known Bridgman-Stockbarger technique could also be employed in conjunction with the present invention. See, for example, J. of Crystal Growth, vol. 21, iss. 1, Jan. 1974, p. 135-140; J. of Crystal Growth, vol. 28, iss. 1, Jan. 1975, p. 36-40; Crystal Research and Technology, vol. 39, iss. 8, pages 692-698, August 2004. The method involves heating polycrystalline material above its melting point and slowly cooling it from one end of a container, where a seed crystal is located. A single crystal of the same crystallographic orientation as the seed material is grown on the seed and is progressively formed along the length of the container. The process can be carried out in a horizontal or vertical geometry. The Bridgman method is a popular way of producing certain semiconductor crystals such as gallium arsenide, for which the Czochralski process is more difficult.

The present invention may also be used in conjunction with electromagnetic casting (EMC). EMC has some similarities to the casting and directional solidifying methods, but also has several unique features that change the ingot properties. EMC is based on induction-heated cold-crucible melt confinement. The shape of the region enclosed by the close-spaced fingers determines the cross section of the cast ingot, and a wide variety of shapes are possible (circular, hexagonal, square, rectangular, etc.). Silicon is melted on a vertically moveable platform (typically graphite) located within the finger array. The melting is accomplished by induction heating after suitable preheating. The induction coil, placed outside the finger array, induces a current to flow on the periphery of each finger, around the finger's vertical axis. Like a high-frequency transformer, each finger in turn induces a current to flow in the periphery of the silicon charge, about its vertical axis.

A liner according to the invention can be used in various crucibles or other containers. In addition, the liner can be used in conjunction with various methods and techniques for melting materials to form ingots.

### Multilayer Liner

The invention relates generally to a liner that comprises at least one layer, but can comprise a plurality of layers. In one disclosed embodiment, the liner comprises at least a fibrous layer, at least an outer layer, and at least an inner layer. The inner and outer layers may be comprised of ceramic materials and/or protective coatings. The liner may be comprised of two or more fibrous layers of the same or differing compositions. The liner may be comprised of two or more ceramic layers of the same or differing compositions. It should be appreciated that the layers of the liner can be configured in a multitude of arrangements comprising one or more fibrous layers and one or more other layers such as one or more ceramic layers. The specific embodiments described herein are not limiting but instead are presented as examples of possible liner configurations. There are numerous possible arrangements of the multiple layers of a liner according to the invention, and this disclosure is intended to cover those possible arrangements whether or not specific layer arrangements are particularly identified herein.

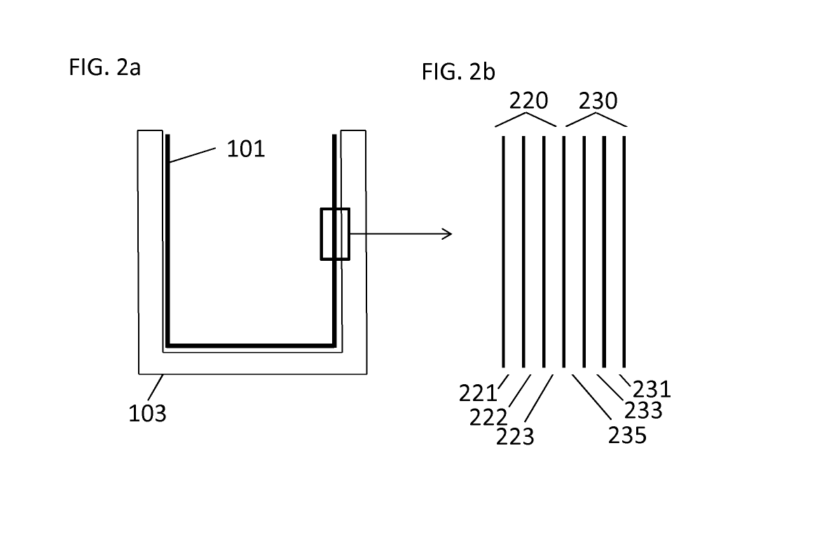

As shown in cross section in FIG. 2a, the liner 101 is inserted into the reusable crucible 103. As depicted in FIG. 2b, the crucible liner 101 can have two layers, 220 and 230. In the depicted embodiment, each of the two layers 220, 230 comprises a fibrous layer 222, 233 as well as two other layers, namely layers 221 and 223 for the inner layer 220 and layers 235 and 231 for the outer layer 230. Coating materials can be used to form the layers 221 and 223 of the inner layer 220 and/or to form the layers 235 and 231 of the outer layer 230. Whether applied as coatings or in some other manner, the layers 221 and 223 of the inner layer 220 and/or the layers 235 and 231 of the outer layer 230 can be different from each other or the same and also can be a single material or some blend or combination of materials. The fibers or filaments in the layer 220 that faces the silicon may have a sizing coating different than a sizing coating used on the fibers or filaments in the layer 230 that faces the crucible.

### Fibrous Layer(s)

The innovative liner may include one or more fibrous layers. The fibers or filaments of each of the fibrous layers can be made of materials that fulfill the temperature (up to 1500° C. for silicon) and purity requirements (impurity content is less than 500 ppm w and preferably is less than 100 ppm w). The texture of the fibrous layer improves the bonding strength of coating materials compared to the smooth surfaces of commonly used silica or graphite crucibles, and the fibrous layer provides the mechanical support for the one or more other layers that make up the liner. The fibrous layer may be an inner, outer, or intermediate layer within the liner. The fibrous layer by itself is flexible, which in turn provides for a completed liner which is at least somewhat flexible. The liner may comprise more than one fibrous layer, and one or more of the multiple fibrous layers may be of differing compositions.

In an aspect of the invention, a fibrous layer of the liner may be formed from carbon fibers or other suitable fibers by consolidating them into a thin walled body mirroring the inside of the crucible. The strength of this fibrous layer may be increased by introducing a binder before filling the space between the fibers with a refractory material such as silicon nitride or silicon carbide. A binder is an ingredient used to bind together two or more materials in a composite and promote adhesion and cohesion of the materials. The fibrous layer of the invention may be comprised of carbon or silicon oxide fibers.

In some embodiments, one or more fibrous layers can comprise non-woven carbon fibers. Carbon fibers are commercially available and have high strength, high modulus, low density, and reasonable cost. Carbon fibers have at least 92 wt. % carbon in composition, and may be short or continuous, and their structure may be crystalline, amorphous, or partly crystalline. Methods of incorporating carbon fibers to form a composite material are known. See for example US 20010049246 A1. The carbon fibers are adhered to the mold by an electrostatic spray coating, a well-known method in the fabrication of fiber reinforced composite parts. See, for example, R Tilney 1953 Br. J. Appl. Phys. 4 S51 doi:10.1088/0508-3443/4/S2/321; and J. of Electrostatics, vol. 66, iss. 3-4, March, 2008, p. 184-189. Composite materials comprising carbon fibers provide for a flexible material to serve as a layer in the liner. This flexibility of the fibrous layer translates into a liner with some flexibility.

In some embodiments, commercially-available chopped carbon fibers are utilized to form one or more fibrous layers. Methods of incorporating chopped carbon fibers may include applying chopped carbon fibers to a mold resembling the dimensions of the crucible. The chopped carbon fibers are adhered to the mold by an electrostatic spray coating, a well-known method in the fabrication of fiber reinforced composite parts. Fiber-reinforced composite materials include fibers of strength and modulus (e.g., carbon fibers or silicon oxide fibers) embedded in or bonded to a matrix.

In some embodiments of the invention, one or more of the layers is a fibrous layer that is made from a woven silicon oxide fiber fabric or other silicon oxide fibrous material, where the fibers or fibrous material is, or is made to be, free or substantially free of impurities. One or more layers of silicon oxide fabric are placed in a polypropylene (PP) or polytetrafluoroethylene (PFTE) mold that has the same inside dimensions as the reusable crucible minus the dimensions of a second exterior layer. In some embodiment of the invention, silicon oxide fibers may comprise the fibrous layer within a constructed liner. Silicon oxide fibers are commercially available. Also, see, for example, U.S. Pat. No. 3,821,070 and J. Polym. Science, Pt. C. No. 19, 267 (1967) regarding silicon oxide fibers. Additionally, fine silicon oxide particles may be included to further close the void space between the fibers and reduce or eliminate the permeability of the liner. The silicon oxide fiber layers are bonded together by the formed silicon oxide matrix, giving the interior liner mechanical integrity while maintaining some amount of flexibility.

In some embodiments of the invention, a fibrous layer of the liner may be or may include a carbon fiber fabric. Carbon fiber fabrics are commercially available in various configurations (weaves, densities, composites, etc.). The fabrics are created from spools of carbon fiber that are woven into fabrics. Carbon fiber fabrics are commercially available from suppliers such as Hexel Inc. and other commercial suppliers. Carbon fiber fabrics are flexible, durable, and strong, and are able to withstand high temperatures.

In an aspect of the invention, the liner is comprised of an inner layer, an outer layer, and one or more fibrous layers positioned between the inner and outer layer. Furthermore, in an aspect of the invention, the outer layer material is not reactive with the crucible. Non reactivity or inertness, can mean, but is not limited to, the lack of change in molecular structure, molecular bonding, chemical bonding, or state. Inertness also implies that chemical components of the materials of the liner do not contaminate the molten material that comes into contact with the liner. It can be appreciated that other layers, including ceramic layers can be used to form the liner.

In an aspect of the invention, the one or more fibrous layers provide mechanical stability to the liner while still allowing the liner to be at least somewhat flexible. In addition, the one or more fibrous layers may be shaped or formed to match the inner surface of the crucible. The liner also can include one or more other layers, including one or more ceramic layers.

In one embodiment of the invention, the liner may be comprised of several layers, including other fibrous layers, however, the outer layer is comprised of a fibrous layer. It can be appreciated that other layers, including ceramic layers can be used to form the liner.

In some embodiment of the invention, the liner is comprised of a plurality of layers, where one or more of the layers is a fibrous layer. The fibrous layers may be of the same are differing compositions. The fibrous layers can be comprised of carbon fibers, silicon oxide fibers, carbon fiber fabric, and/or silicon oxide fabric. For example, a liner with a plurality of layers may comprise a fibrous layer composed of carbon fiber, a fibrous layer composed of silicon oxide fiber, a fibrous layer composed of carbon fiber fabric, a fibrous layer composed of silicon oxide fabric, or any combination thereof.

In some embodiments, a fiber sizing coating may be applied to the fibers or filaments of the fibrous layer. The fiber sizing coating or layer aids in limiting reactivity and improving wetting behavior between the layer and the molten material. Carbon fiber sizing serves as a protective layer that is applied to the fiber to prevent damage during processing. Carbon fiber sizing coatings are commercially available. A second coating or layer may be applied to the fibrous layers to seal voids and control reactivity and wetting behavior with molten silicon (or other molten semiconductor material). Furthermore, additional coatings or layers aid in mechanical properties, for example in releasing the liner from the reusable crucible.

The fibrous layer can be manipulated such that the completed liner has a shape that minors or matches the inner surfaces of the crucible, and the completed liner will have a degree of flexibility or ductility such that it can withstand a certain amount of bending. For example, a crucible liner according to the invention can withstand a bending radius of less than 200 mm without failure. While, at room temperature, one or more layers of the liner may form cracks at a bending radius of a little less than 200 mm, the whole composite that is the liner would not fail and could still be used successfully to line a crucible and create a high-quality silicon ingot.

The texture of the fibrous layer(s) improves the bonding strength of coatings compared to the smooth surfaces of commonly used silica or graphite crucibles. The risk of flaking off of the coating that is caused by a mismatch in the coefficient of thermal expansion or impact of feedstock during charging of the crucible is minimized. While a crucible liner comprising a single fibrous layer may be feasible, additional layers mitigate the risk of defects and failure such as leakage and bonding to crucible. This redundancy increases significantly the reliability of the crucible and crucible liner system.

Two or more fibrous layers of a liner according to the invention may be bonded or held together by stitching or some other technique known in the manufacturing process of textiles and/or composites. The multiple fibrous layers can be bonded or held together in other ways such as, for example, by using one or more high temperature ceramic adhesives to bond the fibrous layers. Such adhesives are available commercially.

### Ceramic Layer(s)

A liner of the present invention may comprise one or more layers that include a ceramic material or a non-metallic refractory material. A ceramic material may be any inorganic crystalline material, compounded of a metal and a non-metal. Ceramics and non-metallic refractory materials generally can withstand very high temperatures such as temperatures that range from 1,000° C. to 1,600° C. (1,800° F. to 3,000° F.). Accordingly, the layer or coating can be made of materials that are non-reactive with the molten semiconductor material and fulfill the temperature and purity requirements (impurity content is less than 500 ppm w). These materials include but are not limited to carbon, silicon carbide, silicon nitride, silicon oxide, silicon oxynitride, silicon oxycarbide, aluminum oxide, boron nitride, or any combinations thereof.

A liner of the present invention may comprise a layer of silicon nitride. Silicon nitride is a ceramic material that displays thermal shock resistance. It does not deteriorate at high temperatures and has unusually high fracture toughness. Application techniques of silicon nitride are known. For example, silicon nitride slurries can be applied by brushing, spraying, etc., and dry silicon nitride powder can be applied by electro deposition. In some embodiments of the invention, the ceramic material is prepared in a slurry or liquid state and is applied to the fibrous layer by brushing, spraying, or some other known application method. Silicon nitride may also be applied to the fabric by employing chemical vapor deposition, and in this regard see, for example, U.S. Pat. No. 5,871,586, U.S. Pat. No. 4,250,210, and Chemical Vapor Deposition Volume 1, Issue 1, pages 8-23, July 1995.

A liner of the present invention may comprise a layer of a silicon dioxide, also referred to as silicon oxide.

A layer of a liner of the present invention may comprise a ceramic layer of silicon carbide, a hard synthetically produced crystalline compound of silicon and carbon. Methods of applying a layer of silicon carbide on a surface are known. See for example, Synthesis of high surface area silicon carbide by fluidized bed chemical vapour deposition, Applied Catalysis A: General 162 (1997) 181-191; and Rapid fabrication of lightweight silicon carbide minors; Optomechanical Design and Engineering 2002, 243-253. For example, the fibrous layer is coated with polysilazane resin and cured in a nitrogen atmosphere to yield silicon carbide.

In one embodiment of the invention, the liner is comprised of an inner layer, an outer layer, and one or more intermediate layers positioned between the inner and outer layer. The inner layer, or layer facing the molten semiconductor material, comprises a ceramic material, which is inert or non-reactive with the molten semiconductor material. It can be appreciated that other layers may be composed of one or more fibrous or ceramic layers. The inner ceramic layer faces the molten semiconductor material, such as molten silicon, and the ceramic material is inert or non-reactive with the molten silicon. In some embodiments, the inner ceramic layer includes carbon, silicon carbide, silicon nitride, silicon oxide, silicon oxynitride, silicon oxycarbide, aluminum oxide, or boron nitride.

In one disclosed embodiment, the layer in contact with the molten material and the layer in contact with the crucible are made from silicon nitride while the intermediate layers may include other materials such as silicon oxide, silicon carbide, or fibrous layers. In one disclosed embodiment, the inner layer of the liner has little or no reactivity with the molten material.

The construction, materials, and compositions of the liner of the invention allow for reusability of the liner. That is, while a new liner typically will be used with the same crucible to form each ingot, it is possible to release the formed ingot from the liner and then to reuse that same liner in the formation of one or more additional ingots.

In an aspect of the invention, the liner is placed in a crucible to prevent contact between the molten material and the interior surfaces of the crucible. The liner, which may be comprised of fibrous and ceramic materials, therefore allows the crucible to be reused. In addition, the liner may comprise a plurality of layers, where at least one layer is a fibrous layer and where at least one layer is a ceramic layer. Furthermore, the fibrous material may be constructed from carbon fibers, carbon fiber fabric, silicon oxide fibers, or silicon oxide fabric, for example.

In an aspect of the invention, the liner, which may be comprised of fibrous and ceramic layers, is placed in a crucible to prevent contact between the molten material and the interior surfaces of the crucible. The liner therefore allows the crucible to be reused. In addition, the liner may comprise a plurality of layers, where at least one layer is a fibrous layer and where at least one layer is a ceramic layer. The plurality of layers can be arranged such that the fibrous layer is in contact with the interior surface of the crucible when the liner is placed in the crucible. In addition, the plurality of the layers may be arranged such that the ceramic layer is configured to be in contact with the molten semiconductor material. The ceramic layer may be comprised of carbon, silicon carbide, silicon nitride, silicon oxide, silicon oxynitride, silicon oxycarbide, aluminum oxide, or boron nitride.

In an embodiment of the present invention, the liner is comprised of a ceramic top layer, which is in contact with the material placed into the liner when the liner is placed in the crucible and a bottom layer that contacts a portion of the interior surface of the crucible when the liner is placed in the crucible. The ceramic top layer may be comprised of carbon, silicon carbide, silicon nitride, silicon oxide, silicon oxynitride, silicon oxycarbide, aluminum oxide, or boron nitride. In addition, the liner may comprise a plurality of intermediate layers. Intermediate layers may be composed of at least one fibrous layer or at least one ceramic layer. Each of the one or more ceramic intermediate layers may be composed of carbon, silicon carbide, silicon nitride, silicon oxide, silicon oxynitride, silicon oxycarbide, aluminum oxide, or boron nitride. Each of the one or more fibrous intermediate layers may be composed of carbon fibers, carbon fiber fabric, silicon oxide fibers, silicon oxide fabric, or any combination thereof.

In an embodiment of the liner of the present invention, when placed into a crucible, prevents molten silicon from contacting the interior surfaces of the crucible, which allows for the crucible to be reused. For example, the liner may comprise an outer fibrous layer that is in contact with the interior of the crucible and an inner ceramic layer which is in contact with the molten silicon. The ceramic layer may be comprised of carbon, silicon carbide, silicon nitride, silicon oxide, silicon oxynitride, silicon oxycarbide, aluminum oxide, boron nitride, or any combinations thereof. The outer fibrous layer may be composed of silicon oxide fibers, carbon fibers, silicon oxide fiber fabrics, carbon fiber fabrics, or any combinations thereof. The liner may also be composed of numerous intermediate layers, for example one or more fibrous layers and/or one or more ceramic layers. It should be appreciated that the fibrous layers may be layers of different composites. For example, a fibrous layer may be composed of carbon fibers, or the fibrous layer may be composed of silicon oxide fibers, carbon fibers, silicon oxide fiber fabrics, carbon fiber fabrics, or any combination thereof. Ceramic layers of the intermediate layers may be comprised of carbon, silicon carbide, silicon nitride, silicon oxide, silicon oxynitride, silicon oxycarbide, aluminum oxide, boron nitride, or any combination thereof.

In another embodiment, the liner of the invention when placed into a crucible prevents silicon from contacting the interior surface of the crucible to thereby allow the crucible to be reused. The exterior portion of the liner is in contact with the interior surface of the crucible when placed in the crucible. The exterior portion of the liner comprises a fibrous material, such as silicon oxide fibers, carbon fibers, silicon oxide fiber fabrics, carbon fiber fabrics, or any combinations thereof. The interior portion of the liner comprises another fibrous layer, whereby each side of the fibrous layer is in contact with a ceramic layer, such as silicon nitride. One side of the interior portion of the liner, with the silicon nitride layer, is in contact with the exterior portion of the liner, and the other side of the interior portion of the liner, with the silicon nitride layer, is in contact with the molten silicon when the liner is placed in the crucible. A fibrous layer can be composed of silicon oxide fibers, carbon fibers, silicon oxide fiber fabrics, carbon fiber fabrics, or any combinations thereof.

The use of fibrous layers to provide the mechanical support of the liner also allows for liner designs that cannot be implemented otherwise. For example, the upper side of the liner can be formed as a lip that geometrically improves the mechanical stability of the liner against inward bending or sagging. The liner can have one or more features that improve its mechanical stability (such as its stiffness) such as notches, folds, bends, etc., and the liner can be constructed into any shape, size, or orientation to fit into any given crucible.

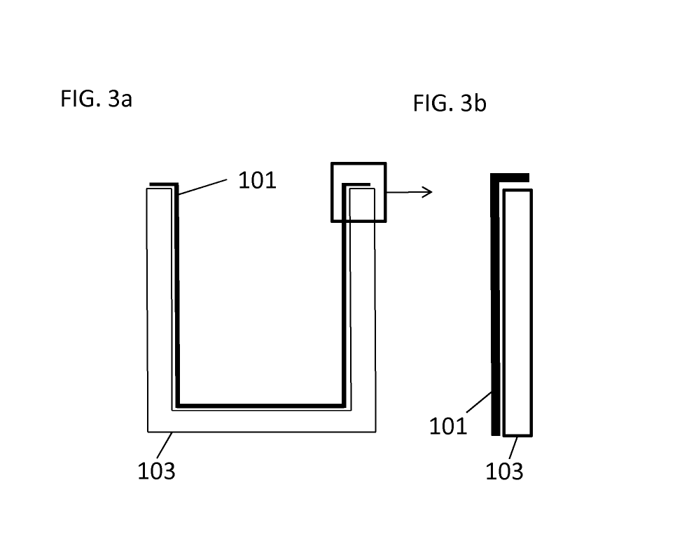

FIGS. 3a and 3b depict a cross-sectional view of the reusable crucible 103 with the liner 101 formed to cover or wrap around the edge of the crucible 103. Again, such a configuration of the liner 101 tends to increase the mechanical stability of the liner 101 and prevent inward bowing or sagging of the liner 101.

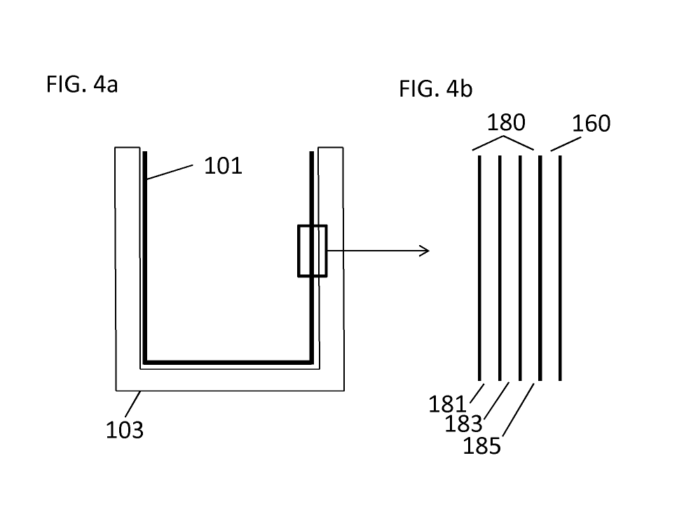

FIGS. 4a and 4b depict cross-sectionally one exemplary embodiment of the crucible liner 101 that is used with the reusable crucible 103 (such as a crucible made of a carbon-carbon composite). As shown in FIG. 4b, the crucible liner 101 can have two layers, namely an interior layer 180 and an exterior layer 160. The interior layer 180 comprises an inside layer 181 (for example, silicon nitride) that is in direct contact with the semiconductor material, a fibrous layer 183 (for example, silicon oxide fibers and a silicon oxide matrix), and an intermediate layer 185 (for example, silicon nitride). In this exemplary embodiment, the exterior layer 160 is solely a fibrous layer such as carbon fiber that can be infiltrated with a polysilazane resin or comparable material.

While it has been described herein that a liner of the present invention typically is used in the formation of silicon ingots, any other semiconductor material can be used in conjunction with the liner. The liner comprises at least a fibrous layer and one other layer such as a ceramic layer. The liner is placed into a reusable crucible to provide a barrier between the semiconductor material and the interior surface of the crucible. The liner/crucible apparatus is then heated to melt the material to a molten state. The molten material is then is allowed to cool. The solid ingot and liner is then removed from the crucible. This method or procedure may be repeated using another similar liner and the same crucible, to make another ingot.

The following examples describe the fabrication and composition of different crucible liners that can be used in combination with a reusable graphite crucible in a growth furnace such as the DSS450HP ingot growth furnace made by GT Advanced Technologies, Inc. The inside dimensions of the crucible for this system, which of course are then the approximate dimensions of the liner, are estimated to be 870 mm in width and length, and 420 mm in height.

### EXAMPLE 1

### Formation of the Fibrous Layer of the Crucible Liner by Carbon Fibers

The fibrous layer of the crucible liner is made from a woven carbon fiber fabric with a metallic impurity content of less than 100 ppm w. Two layers of the carbon fabric are placed in a polypropylene (PP) or polytetrafluoroethylene (PFTE) mold that has the same inside dimensions as the reusable crucible. Alternatively, the fabric bodies can be formed in two or more molds with offset dimensions to allow stacking.

The first and inner fabric layer is taken out of the mold and a silicon nitride layer is applied to the inner surface of the second fabric layer by spraying of a silicon nitride slurry that has a metallic impurity content of less than 100 ppm w. This method is well known in the field for preparing silicon nitride coatings for standard silica crucibles. After drying, the inner fabric layer is reinserted and the silicon nitride slurry is applied and processed in the same fashion. Due to the outside carbon layer, this liner is highly compatible with reusable carbon crucibles that could not be used so far because of the lack of a durable protective coating.

### EXAMPLE 2

### Formation of the Fibrous Layer of the Crucible Liner by Chopped Carbon Fibers

The fibrous layer for the crucible liner is formed from chopped carbon fibers with a metallic impurity content of less than 100 ppm by weight. The carbon fibers can be applied to the mold by electrostatic spray coating; a well-know method in the fabrication of fiber reinforced composite parts. The formed web is further consolidated by spraying a high purity, polysilazane resin on the web. Curing of these binders to form silicon carbide is typically carried out by a heat treatment in a nitrogen atmosphere. Molds with offset dimensions are used to prepare one or more fibrous bodies that can be coated with a silicon nitride layer as described in example 1 and stacked into each other.

### Variations of Examples 1 and 2

Additionally, the fabric fibers may be coated with silicon nitride, silicon oxide or silicon carbide using chemical vapor deposition (Synterials Inc.) before applying a silicon nitride coating. It is obvious that the carbon fibers than be replaced by another suitable fibrous materials such as silicon oxide or silicon carbide. It is also conceivable to combine two fabric layers that are made from different fibrous materials.

### Alternative use of the Liner Material

In zone melting recrystallization (ZMR) a silicon wafer is partially or fully molten and solidified on a substrate material that is commonly moved horizontally through a crystal growth furnace. The above described materials can be made as sheets or ribbons (for example, 156 mm wide to match the standard silicon wafer size) and used as a substrate material in ZMR. Another example of a crystal growth process in which the liner material can be used as a substrate material is horizontal ribbon growth (HRG). In HRG a molten silicon film is continuously formed on a substrate by casting and solidified on it.

References and citations to other documents (such as patents, published patent applications, journals, books, papers, and web content) have been made herein, and it is noted that all such documents are hereby incorporated herein by reference in their entirety for all purposes.

1. A liner for a crucible, comprising:
an inner layer for facing a molten semiconductor material when the liner is placed within the crucible;
an outer layer for facing one or more inner surfaces of the crucible; and
one or more fibrous layers disposed between the inner and outer layers.

2. The liner of claim 1 wherein the inner layer comprises a ceramic material.

3. The liner of claim 2 wherein the inner layer comprises carbon, silicon carbide, silicon oxide, silicon nitride, silicon oxycarbide, silicon oxynitride, boron carbide, boron nitride, or a combination of two or more thereof.

4. The liner of claim 1 wherein the inner layer has no or low reactivity with the molten semiconductor material.

5. The liner of claim 1 wherein the molten semiconductor material is molten silicon.

6. The liner of claim 1 wherein the outer layer comprises a material that is not reactive with the crucible.

7. The liner of claim 1 wherein the outer layer comprises a fibrous material.

8. The liner of claim 1 wherein at least one of the one or more fibrous layers comprises carbon, silicon carbide, silicon oxide, silicon nitride, silicon oxycarbide, silicon oxynitride, boron carbide, boron nitride, or a combination of two or more thereof.

9. The liner of claim 1 wherein at least one of the one or more fibrous layers comprises a fabric.

10. The liner of claim 1 wherein the one or more fibrous layers provide mechanical stability to the liner and also allow the liner to be formed into a shape that matches the inner surfaces of the crucible.

11. A liner for placing into a crucible to prevent material placed into the liner from contacting the interior surfaces of the crucible and for allowing the crucible to be reused, the liner comprising fibrous material and ceramic material.

12. The liner of claim 11 wherein the liner comprises a plurality of layers, at least one of the plurality of layers comprising the fibrous material, at least one other of the plurality of layers comprising the ceramic material.

13. The liner of claim 12 wherein the at least one of the plurality of layers that comprises the fibrous material comprises a fabric.

14. The liner of claim 12 wherein the at least one of the plurality of layers that comprises the fibrous material is configured to contact at least some of the interior surfaces of the crucible when the liner is placed into the crucible.

15. The liner of claim 12 wherein the at least one other of the plurality of layers that comprises the ceramic material is configured to contact material placed into the liner when the liner is placed into the crucible.

16. The liner of claim 12 wherein the at least one other of the plurality of layers that comprises the ceramic material comprises silicon nitride.

17. A liner for a crucible, comprising:
a top layer comprising a ceramic material, a surface of the top layer contacting material placed into the liner when the liner is placed into the crucible; and
a bottom layer comprising a fibrous material, a surface of the bottom layer contacting at least some of interior surfaces of the crucible when the liner is placed into the crucible.

18. The crucible liner of claim 17 wherein the top layer comprises silicon nitride.

19. The crucible liner of claim 17 further comprising one or more intermediate layers between the top layer and the bottom layer.

20. The crucible liner of claim 19 wherein the one or more intermediate layers include a first intermediate layer and a second intermediate layer, the first intermediate layer comprising a second fibrous material, the second intermediate layer comprising silicon nitride.

21. The crucible liner of claim 20 wherein the first intermediate layer comprises silicon oxide fibers and wherein the bottom layer comprises carbon fibers.

22. A liner for placing into a crucible to prevent silicon from contacting the interior surfaces of the crucible and for allowing the crucible to be reused in the making of silicon ingots, the liner comprising:
an outer layer for contacting at least some of the interior surfaces of the crucible when the liner is placed into the crucible, the outer layer comprising a first fibrous material;
an inner layer for contacting silicon placed into the liner when the liner is placed into the crucible, the inner layer comprising silicon nitride; and
a plurality of intermediate layers between the inner and outer layers, the plurality of intermediate layers comprising a first intermediate layer and a second intermediate layer, the first intermediate layer comprising a second fibrous material, the second intermediate layer comprising silicon nitride.

23. The liner of claim 22 wherein each of the first and second fibrous materials comprises a woven fiber fabric.

24. The liner of claim 22 wherein the first fibrous material of the outer layer comprises a carbon fibrous material.

25. The liner of claim 24 wherein the carbon fibrous material comprises a woven carbon fiber fabric.

26. The liner of claim 22 wherein the second fibrous material of the first intermediate layer comprises a silicon oxide fibrous material.

27. The liner of claim 26 wherein the silicon oxide fibrous material comprises a woven silicon oxide fiber fabric.

28. The liner of claim 22 wherein the second intermediate layer comprises a coating of silicon nitride on one side of the first intermediate layer.

29. The liner of claim 28 wherein the inner layer comprises a coating of silicon nitride on the other side of the first intermediate layer.

30. A liner for placing into a crucible to prevent silicon from contacting the interior surfaces of the crucible and for allowing the crucible to be reused in the making of silicon ingots, the liner comprising:
an exterior portion configured to contact at least some of the interior surfaces of the crucible when the liner is placed into the crucible, the exterior portion comprising a first fibrous material; and
an interior portion comprising a second fibrous material, a first silicon nitride coating on a first side of the second fibrous material, and a second silicon nitride coating on a second side of the second fibrous material, the first silicon nitride coating adjoining the exterior portion, the second silicon nitride coating configured to contact silicon placed into the liner when the liner is placed into the crucible.

31. The liner of claim 30 wherein each of the first and second fibrous materials comprises a woven fiber fabric.

32. The liner of claim 30 wherein the first fibrous material of the exterior portion comprises a carbon fibrous material.

33. The liner of claim 32 wherein the carbon fibrous material comprises a woven carbon fiber fabric.

34. The liner of claim 30 wherein the second fibrous material of the interior portion comprises a silicon oxide fibrous material.

35. The liner of claim 34 wherein the silicon oxide fibrous material comprises a woven silicon oxide fiber fabric.

36. A method of making silicon ingots, comprising
placing a liner into a crucible to create a lined crucible, the liner comprising a fibrous material and a ceramic material;
heating the lined crucible when it contains silicon to melt the silicon contained within the lined crucible;
removing the liner from the crucible after the melted silicon has cooled sufficiently to form a solid silicon ingot, the solid silicon ingot being removed from the crucible along with the liner; and
repeating the placing, heating, and removing steps using the crucible with another liner to make another solid silicon ingot, the other liner also comprising the fibrous material and the ceramic material.
